(19) United States
(12) Patent Application Publication
(10) Pub. No.: US 2014/0365026 A1
(43) Pub. Date: Dec. 11, 2014

(54) SIGNATURE GENERATING APPARATUS, SIGNATURE GENERATING METHOD, COMPUTER PROGRAM PRODUCT, AND ELECTRICAL POWER CONSUMPTION CALCULATION SYSTEM

(71) Applicant: KABUSHIKI KAISHA TOSHIBA, Tokyo (JP)

(72) Inventors: Yuichi Komano, Kawasaki-shi (JP); Yoshikazu Hanatani, Kawasaki-shi (JP)

(73) Assignee: KABUSHIKI KAISHA TOSHIBA, Tokyo (JP)

(21) Appl. No.: 14/196,905

(22) Filed: Mar. 4, 2014

(30) Foreign Application Priority Data
Jun. 11, 2013 (JP) 2013-122412

(51) Int. Cl. G05B 15/02

(52) U.S. Cl. CPC G05B 15/02
USPC 700/297

(57) ABSTRACT

According to an embodiment, a signature generating apparatus includes a generator and an updater. The generator is configured to generate a data sequence including a predetermined number of pieces of first tentative data, and a tentative signature corresponding to the data sequence. The updater is configured to update the tentative signature by replacing the piece of first tentative data with a piece of first actual data, and generate a signature corresponding to a data sequence including the pieces of first actual data by replacing all of the pieces of first tentative data with the respective pieces of first actual data.

### CROSS-REFERENCE TO RELATED APPLICATION

This application is based upon and claims the benefit of priority from Japanese Patent Application No. 2013-122412, filed on Jun. 11, 2013; the entire contents of which are incorporated herein by reference.

### FIELD

Embodiments described herein relate generally to a signature generating apparatus, a signature generating method, a computer program product, and an electrical power consumption calculation system.

### BACKGROUND

An electrical power consumption calculation system calculates a total amount of electrical power consumption by measuring the amount of electrical power consumptions per unit time, and calculating the sum of the measurement data. Therefore, if the amount of electrical power consumption thus measured is tampered by any third party, for example, the system can be incapable of correctly performing calculations based on the amount of electrical power consumption, and of providing functions correctly based on the calculations. An electrical power consumption calculation system therefore needs to be ensured the authenticity of the amount of electrical power consumption. To address this issue, conventionally known is a technology for generating signature to ensure the data authenticity.

However, conventional technologies incurs high processing costs such as a high computational load and an extended processing time, and is incapable of generating a signature efficiently.

### BRIEF DESCRIPTION OF THE DRAWINGS

FIG. 1 is a schematic diagram of an example of the configuration of an electrical power consumption calculation system according to an embodiment;

FIG. 2 is a schematic diagram of an example of an apparatus configuration of a smart meter (SM) according to the embodiment;

FIGS. 3A and 3B are schematics of signature generating methods;

FIG. 4 is a schematic diagram of an example of a functional configuration of the SM according to the embodiment;

FIG. 5 is a schematic diagram of an example of a functional configuration of a meter data management system (MDMS) according to the embodiment;

FIG. 6 is a schematic diagram of an example of a functional configuration of an application system according to the embodiment;

FIG. 7 is a flowchart illustrating an example of a process performed in the SM according to the embodiment;

FIG. 8 is a flowchart illustrating an example of a process performed in the MDMS according to the embodiment; and

FIG. 9 is a flowchart illustrating an example of a process performed in the application system according to the embodiment.

### DETAILED DESCRIPTION

According to an embodiment, a signature generating apparatus includes a generator and an updater. The generator is configured to generate a data sequence including a predetermined number of pieces of first tentative data, and a tentative signature corresponding to the data sequence. The updater is configured to update the tentative signature by replacing the piece of first tentative data with a piece of first actual data, and generate a signature corresponding to a data sequence including the pieces of first actual data by replacing all of the pieces of first tentative data with the respective pieces of first actual data.

A signature generating apparatus, a signature generating method, and a signature generating program according to an embodiment will now be explained in detail with reference to the appended drawings.

System Overview

To begin with, an overview of an electrical power consumption calculation system according to an embodiment will now be explained. In a next-generation power grid called a smart grid, a smart meter (SM), which is comparable to an electricity meter that summarizes the amount of electrical power consumed by electrical appliances, is installed in each area of a residence or the like for which the electrical power consumptions is to be summarized. The SM communicates with a meter data management system (MDMS), which is comparable to a data management apparatus, via the power grid. The MDMS collects the amount of electrical power consumption per unit time from the SM. The amount of electrical power consumption collected by the MDMS is used by a billing server or a visualizing server included in the electrical power consumption calculation system, for example. The billing server acquires the total amount of the electrical power consumptions over a predetermined time period based on the amounts of electrical power consumption per unit time collected by the MDMS, and performs a process of billing each residence for the corresponding amount of electrical power consumption. The visualizing server performs a visualizing process such as displaying a graph of the amount of electrical power consumption per unit time collected by the MDMS and providing suggestive information for power saving activities, in response to a request from each residence. In this manner, the billing server and the visualizing server use the amount of electrical power consumption collected by the MDMS from the SM in executing the billing process or the visualizing process.

System Configuration

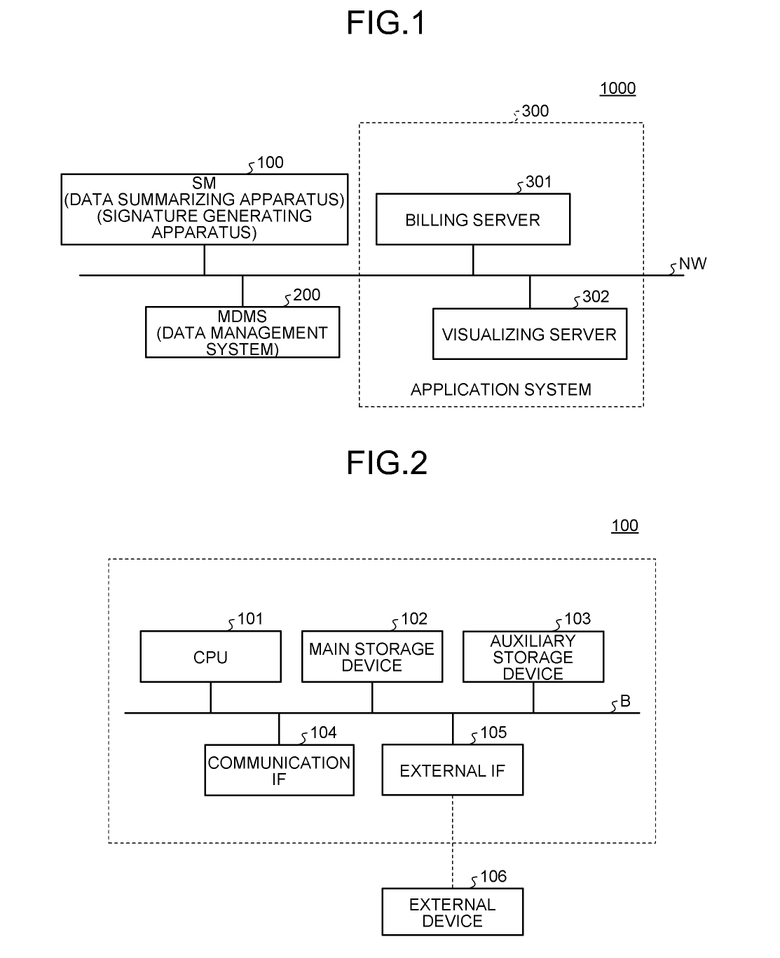

FIG. 1 is a schematic diagram of an example of the configuration of an electrical power consumption calculation system 1000 according to the embodiment. As illustrated in FIG. 1, this electrical power consumption calculation system 1000 according to the embodiment includes an SM 100, an MDMS 200, and an application system 300 connected to each other over a data transfer channel NW. Examples of the data transfer channel NW includes a local area network (LAN), an intranet, an Ethernet (registered trademark), and the Internet. Communications over the data transfer channel NW may be encrypted communications over the open secure sockets layer (SSL), for example.

The SM 100 is a data summarizing apparatus that summarizes the amount of electrical power consumptions by the electrical appliances per unit time in a target area. The target area herein means each of the areas in a residence in which the SM 100 is installed, for example. The unit time herein means a time period representing a period over which the amount of electrical power consumption are to be summarized, and may be 15 minutes or 30 minutes, for example.

The SM 100 also serves as a signature generating apparatus that generates a signature for ensuring the authenticity of the amount of electrical power consumption. For this purpose, the SM 100 retains a secret key used in generating a signature and a validation key used in validating a signature. The secret key and the validation key may be stored in the SM 100 as a factory default, or may be generated internally when the SM 100 is installed. Alternatively, a key management server (not illustrated) may manage a secret key and a validation key generated by the key management server, and may provide these keys to the SM 100 installed on-site over the data transfer channel NW, for example.

The amount of electrical power consumption per unit time summarized by the SM 100 is associated at least with identification information for identifying the SM 100 (hereinafter, referred to as “SM identification information”) and to time information indicating the time at which the amount of electrical power consumption is summarized (hereinafter, referred to as “summarization time information”). The SM 100 then generates a signature corresponding to the amount of electrical power consumption, using the SM identification information and the summarization time information associated to the amount of electrical power consumption, and the secret key, for example. A signature corresponding to the amount of electrical power consumption may be generated using additional information associated to the amount of electrical power consumption, other than the SM identification information and the summarization time information.

The MDMS 200 is a data management system that collects the amounts of electrical power consumption from the SM 100 over the data transfer channel NW, and manages the amounts of electrical power consumption. The MDMS 200 manages the amounts of electrical power consumption collected from the respective SMs 100 using the SM identification information. Although the SM 100 is illustrated in singularity in FIG. 1, because the SM 100 is installed in each residence and the like as mentioned earlier, the SM 100 is generally connected in plurality to the electrical power consumption calculation system 1000. Therefore, the MDMS 200 manages the amounts of electrical power consumption collected from a plurality of respective SMs 100. The MDMS 200 may be implemented on a plurality of information processing apparatuses, or may be implemented on one information processing apparatus. The MDMS 200 according to the embodiment is implemented on one information processing apparatus. Therefore, the MDMS 200 according to the embodiment corresponds to a data management apparatus.

The application system 300 is a function provider system that provides a given function by executing application software. The application system 300 may be implemented on a plurality of information processing apparatuses, or may be implemented on one information processing apparatus. When the application system 300 is implemented on a plurality of information processing apparatuses, some of the information processing apparatuses may be shared with those implementing the MDMS 200. The application system 300 according to the embodiment is implemented on a plurality of information processing apparatuses, e.g., a billing server 301 providing a billing function and a visualizing server 302 providing a function of visualizing the amounts of electrical power consumption and the like. Therefore, the billing server 301 and the visualizing server 302 according to the embodiment correspond to application servers (function provider apparatuses).

The billing server 301 performs a process of billing residences or the like for their amounts of electrical power consumption in the respective target areas, based on the total amounts of electrical power consumed over a billing period in the respective target area. The billing period herein means a time period, or time and dates for indicating the period over which electrical power consumption is to be billed (a period on which the application is run), and is one month or two months, for example. The visualizing server 302 performs a process of visualizing the amount of electrical power consumption per unit time in a target area, and provides visualized information. Each of the billing server 301 and the visualizing server 302 may be implemented on a plurality of information processing apparatuses, or may be implemented on one information processing apparatus.

Each of the MDMS 200, the billing server 301, and the visualizing server 302 retains SM identification information or identification information for identifying a target area (hereinafter, referred to as “target area identification information”). Each of the MDMS 200, the billing server 301, and the visualizing server 302 also retains a validation key to be used in validating a signature generated by the SM 100. The validation key is received from the SM 100 over the data transfer channel NW, and retained in the MDMS 200, the billing server 301, and the visualizing server 302.

An example of a general operation of the electrical power consumption calculation system 1000 according to the embodiment will now be explained. The SM 100 summarizes the amount of electrical power consumption per unit time, and generates a signature corresponding to a data sequence including the amount of electrical power consumption with the secret key. The SM 100 then transmits the data sequence of the amount of electrical power consumption and the signature thus generated to the MDMS 200. When the data is received, the MDMS 200 validates the data thus received using the validation key, to confirm if the received data is not tampered. If the MDMS 200 confirms that the received data is not tampered, the MDMS 200 retains the received data. If the MDMS 200 confirms that the received data is tampered, the MDMS 200 outputs an error.

The billing server 301 requests the amounts of electrical power consumption over the billing period from the MDMS 200, and receives the corresponding data sequence of the amounts of electrical power consumption and a corresponding signature from the MDMS 200. When the data is received, the billing server 301 validates the data thus received using the validation key, to confirm if the received data is not tampered. If the billing server 301 confirms that the received data is not tampered, the billing server 301 performs a billing process based on the amount of electrical power consumption over the billing period. If the billing server 301 confirms that the received data is tampered, the billing server 301 outputs an error.

The visualizing server 302 requests the amounts of electrical power consumption each summarized per unit time from the MDMS 200, and receives the corresponding data sequence of the amounts of electrical power consumption and a corresponding signature from the MDMS 200. When the data is received, the visualizing server 302 validates the received data using the validation key, to confirm if the received data is not tampered. If the visualizing server 302 confirms that the received data is not tampered, the visualizing server 302 visualizes the amounts of electrical power consumption per unit time, and provides the visualized information. If the visualizing server 302 confirms that the received data is tampered, the visualizing server 302 outputs an error.

Apparatus Configuration

FIG. 2 is a schematic diagram of an example of an apparatus configuration of the SM 100 according to the embodiment. As illustrated in FIG. 2, the SM 100 includes a central processing unit (CPU) 101, a main storage device 102, an auxiliary storage device 103, a communication interface (IF) 104, and an external IF 105 connected to each other over a bus B.

The CPU 101 is a processor for controlling the entire apparatus and for achieving the functions provided to the SM 100. The main storage device 102 is a memory for storing computer programs, data, and the like in predetermined memory areas. Examples of the main storage device 102 include a read-only memory (ROM) and a random access memory (RAM). The auxiliary storage device 103 is a memory with a memory area having a capacity larger than that of the main storage device 102. The auxiliary storage device 103 is a non-volatile memory such as a hard disk drive (HDD) or a memory card. The auxiliary storage device 103 may include a storage medium such as a flexible disk (FD), a compact disk (CD), and a digital versatile disk (DVD). The CPU 101 provides the controlling of the entire apparatus and functions provided to the SM 100 by reading a computer program and data from the auxiliary storage device 103 to the main storage device 102, and executing the process, for example.

The communication IF 104 is an interface for connecting the SM 100 to the data transfer channel NW. Such a connection allows the SM 100 to exchange data with the MDMS 200, the billing server 301, or the visualizing server 302. The external IF 105 is an interface for allowing the SM 100 to exchange data with an external device 106. An example of the external device 106 includes a meter (sensor) for measuring the amounts of electrical power consumption. In this manner, the SM 100 is allowed to summarize the amount of electrical power consumption.

The SM 100 may also include a display device (not illustrated) for displaying various types of information such as visualized amounts of electrical power consumption, and an input IF (not illustrated) such as an operation button for receiving an operation input performed by a user. Because each of the MDMS 200, the billing server 301, and the visualizing server 302 is an information processing apparatus such as a personal computer (PC), explanations of its apparatus configurations are omitted herein.

In the manner described above, the electrical power consumption calculation system 1000 according to the embodiment provides an electrical power consumption management service with ensured data authenticity.

Functional Configuration

Functions provided to the electrical power consumption calculation system 1000 according to the embodiment will now be explained. The SM 100 according to the embodiment generates a data sequence including a predetermined number of pieces of the first tentative data each corresponding to the amount of electrical power consumption per unit time, and a tentative signature in advance. The SM 100 then summarizes the amount of electrical power consumption per unit time in the target area. The SM 100 replaces a piece of the first tentative data at corresponding time with the amount of electrical power consumption per unit time (first actual data), and updates the data sequence and the tentative signature. When all of the pieces of the first tentative data in the data sequence are replaced with the respective amounts of electrical power consumption (first actual data), the tentative signature is updated as a signature corresponding to the data sequence of the amounts of electrical power consumption (first actual data). The SM 100 then transmits the data sequence and the tentative signature to the MDMS 200. When the data is received from the SM 100, the MDMS 200 is caused to retain the data. The MDMS 200 also transmits the data sequence and the tentative signature received from the SM 100 to the application system 300 when there is a request from the application system 300. When the data is received from the MDMS 200, the application system 300 runs the application based on the data thus received, to provide a given function.

The first tentative data herein is information that is tentatively established by a signature generating apparatus according to the embodiment (the SM 100) and used in generating a tentative signature (the information serving as a document to be signed by a signing algorithm). To generate a tentative signature, the signature generating apparatus according to the embodiment uses one or more pieces of random number information. Therefore, second tentative data, which will be described later, serves as an initial value of the random number information, and is information tentatively established by the signature generating apparatus according to the embodiment. The first actual data herein means a piece of information input from external, in replacement of the first tentative data, to the signature generating apparatus according to the embodiment. The signature generating apparatus according to the embodiment replaces the first tentative data with the first actual data, and updates the tentative signature to a signature. At this time, the signature generating apparatus according to the embodiment updates the second tentative data to second actual data.

In the electrical power consumption calculation system 1000, if the amount of electrical power consumption is tampered by any third party or the like, applications can fail to run correctly to be incapable of providing appropriate functions to users (incapable of correctly performing calculations based on the amount of electrical power consumption, and of correctly providing the functions based on the calculations). To address this, required is a signature generating method for ensuring the authenticity of a sequence of data that is chronologically continuous, such as that including the amounts of electrical power consumption.

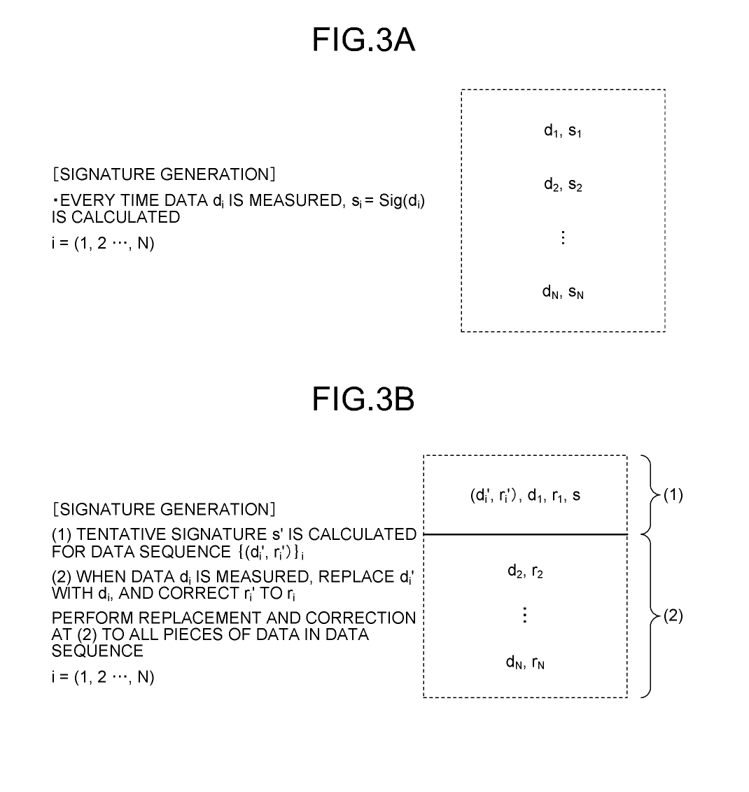

FIGS. 3A and 3B are schematics of signature generating methods. FIG. 3A summarizes a conventional signature generating method. As illustrated in FIG. 3A, in the conventional signature generating method, for example, every time data dᵢ of the amount of electrical power consumption is measured, a signature sᵢ (=Sig(dᵢ)) corresponding to the measurement data dᵢ is calculated. In the conventional method, in proportion to the number N of pieces of data in a data sequence, the computational load (processing amount) required in generating signatures and the size of signatures are increased, and a processing time is extended. In this manner, the conventional technology incurs high processing costs, and is incapable of generating signatures efficiently.

Therefore, it is desirable for a system such as the electrical power consumption calculation system 1000 that handles a sequence of data that is chronologically continuous to be ensured of the authenticity of the data sequence with an efficient signature generating process.

To address issue, a signature generating method illustrated in FIG. 3B is disclosed in the embodiment. FIG. 3B generally illustrates the signature generating method according to the embodiment. As illustrated in FIG. 3B, in the signature generating method according to the embodiment, a combination of predetermined first tentative data and second tentative data (dᵢ′, rᵢ′) is generated, and a tentative signature s′ (=Sig({(dᵢ′, rᵢ′)}ᵢ)) corresponding to the data sequence {(dᵢ′, rᵢ′)}ᵢ is calculated in advance. In the signature generating method according to the embodiment, when the data of the amount of electrical power consumption is measured subsequently, the tentative data dᵢ′ (first tentative data) is replaced with the measurement data dᵢ (first actual data). In the signature generating method according to the embodiment, the second tentative data rᵢ′ is then updated (corrected) to second actual data rᵢ to update the tentative signature s′ to a tentative signature after the data is replaced (=Sig ({(dⱼ, rⱼ)}_{j≦i, {(d}ₖ′, rₖ′)}_{k>i}) for the measurement data dᵢ (first actual data). In this replacement, the tentative signature s′ results in the same value as the tentative signature s′ before the replacement. As a result, in the signature generating method according to the embodiment, after all of the pieces of the first tentative data dᵢ′ in a data sequence are replaced and the second tentative data rᵢ′ serving as a random number component is corrected, the tentative signature s′ is updated as a signature s corresponding to the data sequence of the amounts of electrical power consumption. In the manner described above, in the signature generating method according to the embodiment, a tentative signature is generated for a data sequence including pieces of the first tentative data in advance, and the data sequence and the tentative signature are updated once the amount of electrical power consumption (first actual data) is measured.

Because the signature generating method according to the embodiment enables the signature generating process to be executed in advance using the idle time of the CPU 101, the process performed subsequently to the measurement of the amount of electrical power consumption can be reduced. Furthermore, when the amount of computations required in updating a signature is smaller than that in generating a signature, the signature generating method according to the embodiment enables measurements of electrical power consumptions to be transmitted quickly. Furthermore, because the signature generating method according to the embodiment does not generate one signature for each amount of electrical power consumption, the signature size is independent of the number of data pieces in the data sequence (the signature size remains constant). Furthermore, because the signature generating method according to the embodiment can validate the signature every time the amount of electrical power consumption is measured and the tentative data is replaced (updated), the authenticity of the data sequence of the amounts of electrical power consumption can be ensured. In other words, in the signature generating method according to the embodiment, the authenticity of a data sequence can be ensured using an efficient signature generating process.

A functional configuration and an operation of the electrical power consumption calculation system 1000 according to the embodiment will now be explained. The functions of the electrical power consumption calculation system 1000 according to the embodiment can be classified into functions provided to the SM 100, functions provided to the MDMS 200, and functions provided to the application system 300.

Function of SM 100

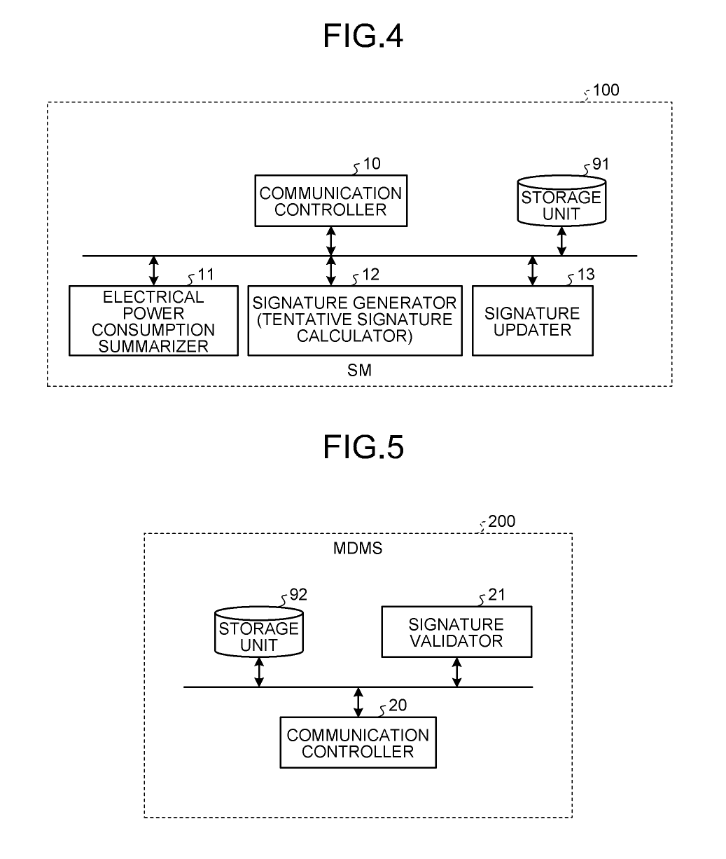

FIG. 4 is a schematic diagram of an example of a functional configuration of the SM 100 according to the embodiment. As illustrated in FIG. 4, the functions of the SM 100 according to the embodiment include a communication controller 10, an electrical power consumption summarizer 11, a signature generator (tentative signature calculator) 12, and a signature updater 13. Each of these functional units is achieved by software implementation. Therefore, each of these functional units is a function achieved by causing the CPU 101 to execute a computer program. The communication controller 10 may be achieved by causing a processor provided to the communication IF 104 to execute a computer program. The electrical power consumption summarizer 11 may be achieved by hardware implementation. For example, the electrical power consumption summarizer 11 may be achieved as a circuit that summarizes the amounts of electrical power consumption measured by measurement instruments. The functions of the SM 100 according to the embodiment also include a storage unit 91. The storage unit 91 corresponds to a given memory area in the auxiliary storage device 103 provided to the SM 100, for example.

The communication controller 10 controls data communications between the SM 100 and the MDMS 200. Specifically, the communication controller 10 receives control commands from the MDMS 200. The communication controller 10 also transmits a data sequence of the amounts of electrical power consumption and a tentative signature received from the signature generator 12 or from the signature updater 13 to the MDMS 200.

The electrical power consumption summarizer (receiver) 11 receives measurements of electrical power consumption from electrical appliances in the target area every time a predetermined time elapses, and summarizes the measurements once in a unit time. The electrical power consumption summarizer 11 stores the amount of electrical power consumption thus calculated in the storage unit 91. The electrical power consumption summarizer 11 also controls operations of summarizing the amount of electrical power consumption (to start or to end the process of calculating the sum, to interrupt or to stop the process of calculating the sum) based on the control commands received by the communication controller 10.

The storage unit 91 stores therein the secret key used by the signature generator 12 and the signature updater 13, and the data sequence of the amounts of electrical power consumption and the tentative signature output from the signature generator 12 or the signature updater 13. The data sequence of the amounts of electrical power consumption and the signature thus stored are deleted when a predetermined time elapses. The predetermined time herein means a time indicating for which, or time and date indicating the time until which the data sequence of the amounts of electrical power consumption and the signature are retained, and is two weeks or 30 days, for example. The predetermined time may be specified to any time within a range not causing the memory area capacity to be exceeded by the amount of data to be stored for the data sequence of the amounts of electrical power consumption and the signature during the system operation.

The signature generator 12 generates a data sequence including a predetermined number of pieces of the first tentative data, and calculates and generates a tentative signature (initial signature) using the secret key stored in the storage unit 91. The predetermined number herein means the number of pieces of the first actual data to be included in a data sequence corresponding to one signature. For example, when one signature is generated a day, and the unit time over which the amount of electrical power consumption (first actual data) is summarized is 15 minutes, the predetermined number is 96 (=24 hours/15 minutes). In this manner, the signature generator 12 is caused to generate a data sequence including 96 pieces of the first tentative data each piece of which corresponds to the amount of electrical power consumption per unit time. The first tentative data herein means an initial value of the first actual data, and the second tentative data herein means an initial value of the second actual data that is used as a random number component. Each of the first tentative data and the second tentative data is data containing a predetermined value, a random number randomly selected in advance, or a combination of these two. The predetermined value may be a fixed value such as zero or one, or a value that is based on the SM identification information or the summarization time information.

The signature generator 12 calculates and generates a tentative signature using a method described below. Explained in the embodiment is an example in which calculations for generating a signature is performed using a group element. For the purpose of convenience, in the description below, it is assumed that the unit time for which the amount of electrical power consumptions is to be summarized is 15 minutes, and the number of data pieces in the data sequence is 96. Detailed explanations of this method are substituted by the disclosure in Masayuki Abe, Georg Fuchsbauer, Jens Groth, Kristiyan Haralambiev, Miyako Ohkubo, Structure-Preserving Signatures and Commitments to Group Elements. CRYPTO 2010: 209-236.

Signature Generating Method

The storage unit 91 stores therein a following secret key sk (={u₁, u₂, . . . , u₉₇, v}) and validation key vk (={G, H, U₁, U₂, . . . , U₉₇, V}) based on the conditions mentioned above. The secret key sk includes 98 (=the number of data pieces in a data sequence+2) integers u₁, u₂, u₉₇, and v which ranges from zero to p−1. The validation key vk includes G and H, and 98 group elements Uᵢ (=G^{ui}(i=1, 2, . . . , 97)) and V (=H^{v}). G and H are generators (elements) of cyclic groups of order p, and a paring operation can be performed on the elements of a cyclic group generated by G and those of a cyclic group generated by H. In other words, when e is the function of the pairing operation, e(G^{a}, H^{b})=e(G^{ab}, H)=e(G, H^{ab})=e(G^{a}, H)^{b}=e(G, H^{b})^{a}=e(G, H)^{ab}, for example, is established for a and b each of which is an integer equal to or more than zero and less than p.

To begin with, the signature generator 12 establishes 96 (=the number of data pieces in a data sequence) pieces of the first tentative data N₁, . . . , N₉₆ and a piece of second tentative data N₉₇. The signature generator 12 then randomly selects an integer r that is equal to or more than zero and less than p, and calculates the following Equation (1).

R=G^{r} (1)

The signature generator 12 then calculates the following Equations (2) and (3).

S=R^{v}(=G^{rv}) (2)

T=(HΠₗ₌₁, . . . ,₉₇Nₗ^{-l})^{1/r} (3)

where Πₗ₌₁, . . . , ₖAₗ in Equation (3) represents A₁*A₂* . . . *Aₖ.

The signature generator 12 uses the calculation result (R, S, T) as a tentative signature. In the manner explained above, the signature generator 12 according to the embodiment generates a tentative signature.

The signature updater 13 updates the tentative signature by replacing the first tentative data in the data sequence generated by the signature generator 12 with the amount of electrical power consumption (first actual data) summarized by the electrical power consumption summarizer 11, and updating (correcting) the second tentative data serving as the random number component. The signature updater 13 updates the tentative signature based on the method described below. In the following explanation, for the purpose of convenience, N₁, . . . , N₉₆ represent the initial values (first tentative data) of the measurement data of the amounts of electrical power consumption, and N₉₇ represents the initial value (second tentative data) serving as the random number component.

Signature Updating Method

After the electrical power consumption summarizer 11 measures the j-th electrical power consumption Pⱼ, the signature updater 13 replaces the j-th first tentative data Nⱼ with the measurement of the electrical power consumption Pⱼ (first actual data), and updates the random number component (second tentative data). At this time, the signature updater 13 calculates Equation (4) below, and updates (corrects) the random number component (second tentative data) with a value thus calculated.

N₉₇′=(Nⱼ/Pⱼ)^{uj/u97}N₉₇ (4)

For l that is more than j and less than 97, the signature updater 13 may generate new tentative data Nₗ′, and calculate the following Equation (5) instead of Equation (4).

N₉₇′=(Nⱼ/Pⱼ)^{uj/u97} . . . Πₗ₌ⱼ₊₁, . . . ,₉₆(Nₗ/Nₗ′)^{ul/u97}*N₉₇ (5)

Employing the method described above, the signature updater 13 according to the embodiment updates a tentative signature by replacing all pieces of the first tentative data in a data sequence with a plurality of respective amounts of electrical power consumption each summarized by the electrical power consumption summarizer 11, and generates a signature corresponding to the data sequence of the amounts of electrical power consumption each summarized by the electrical power consumption summarizer 11.

In the description below, a new piece of the first tentative data Nₗ′ generated by the signature updater 13 and a random number component (second tentative data) N₉₇′ calculated by the signature updater 13 are redenoted as Nₗ and N₉₇, respectively, as long as such redenotation does not cause any confusion.

The signature updater 13 may perform the following calculation before the amount of electrical power consumption Pᵢ is measured. For example, Nⱼ^{uj/u97}N₉₇ and uⱼ/u₉₇ in Equation (4) may be calculated in advance, and (Nⱼ^{uj/u97}N₉₇)*(1/Pᵢ)^{uj/u97} may be calculated after the amount of electrical power consumption Pᵢ is measured.

In the description below, the actual measurement data of the amount of electrical power consumption (first actual data) is denoted by Pᵢ, and N₉₇ when all of N₁, . . . , N₉₆ are replaced with the respective actual measurements is referred to as an actual random number component (second actual data).

Functions of MDMS 200

FIG. 5 is a schematic diagram of an example of a functional configuration of the MDMS 200 according to the embodiment. As illustrated in FIG. 5, the functions of the MDMS 200 according to the embodiment include a communication controller 20 and a signature validator 21. Each of these functional units is achieved by software implementation. Therefore, each of these functional units is achieved by causing a CPU (not illustrated) provided to the MDMS 200 to execute a computer program. The communication controller 20 may be achieved by causing a processor provided to a communication IF (not illustrated) in the MDMS 200 to execute a computer program. The functions of the MDMS 200 according to the embodiment also include a storage unit 92. The storage unit 92 corresponds to a given memory area in an auxiliary storage device (not illustrated) provided to the MDMS 200, for example.

The communication controller 20 controls data communications with other apparatus such as the SM 100 and the application system 300. Specifically, the communication controller 20 receives a data sequence and a tentative signature from the SM 100. The communication controller 20 also receives the amount of electrical power consumption from the SM 100 once in a unit time. The communication controller 20 also transmits control commands to the SM 100. The control commands transmitted to the SM 100 are commands for controlling the operations of summarizing the amount of electrical power consumption. Examples of such commands include those for instructing to start and to end the process of summarizing the amount of electrical power consumption, to interrupt or to stop the process of summarizing the amount of electrical power consumption, and to transmit the amount of electrical power consumption. The communication controller 20 also receives a request for acquiring the amount of electrical power consumption from the billing server 301 or the visualizing server 302 included in the application system 300, and transmits the data sequence to the requestor as a response to the acquisition request.

The storage unit 92 stores therein the data sequence, the tentative signature, the amount of electrical power consumption per unit time, and the like that are received by the communication controller 20 from the SM 100.

The signature validator 21 validates if a tentative signature received from the SM 100 is a legitimate signature for a data sequence received from the SM 100. In other words, the signature validator 21 validates the data received from the SM 100, to confirm if the received data is not tampered.

The signature validator 21 validates a tentative signature based on the following method. Explained below is a specific example in which validated is a tentative signature generated by the signature generator 12 and updated by the signature updater 13.

Signature Validation Method

The signature validator 21 validates the data sequence (N₁, . . . , N₉₇) and the tentative signature (R, S, T) using Equations (6) and (7) below. When Nᵢ is replaced with the amount of electrical power consumption Pᵢ, the signature validator 21 replaces Ni with Pᵢ, and then calculates Equations (6) and (7).

e(R,V)=e(S,H) (6)

e(R,T)Πₗ₌₁, . . . ,₉₇e(Uₗ,Nₗ)=e(G,H) (7)

where G, H, U, and V in Equations (6) and (7) are the values included in the validation key vk.

If Equations (6) and (7) are both established, the signature validator 21 determines that the tentative signature being validated is a legitimate signature for the data sequence (confirms that the received data is not tampered), and stores the received tentative signature. If any of Equation (6) or (7) is not established, the signature validator 21 determines the tentative signature being validated is not a legitimate signature for the data sequence (confirms that the received data is tampered), and does not store (discards) the received tentative signature. Based on the method described above, the signature validator 21 according to the embodiment validates a tentative signature.

Functions of Application System 300

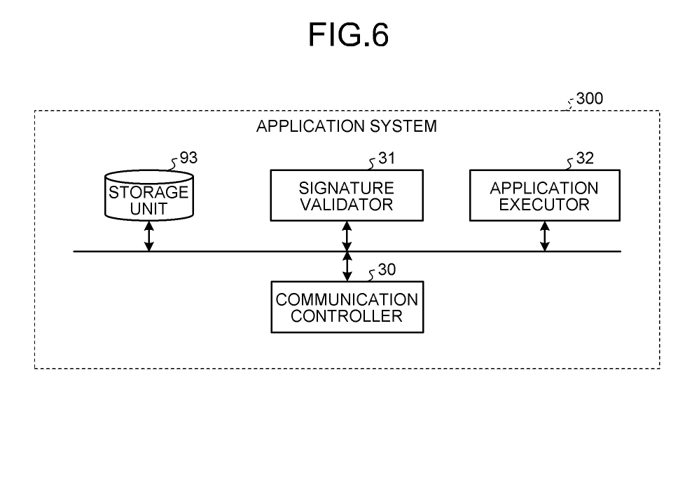

FIG. 6 is a schematic diagram of an example of a functional configuration of the application system 300 according to the embodiment. As illustrated in FIG. 6, the functions of the application system 300 according to the embodiment include a communication controller 30, a signature validator 31, and an application executor 32. Each of these functional units is achieved by software implementation. Therefore, each of the functional units is a function achieved by causing a CPU (not illustrated) in the billing server 301 or to the visualizing server 302 to execute a computer program. The communication controller 30 may be achieved by causing a processor in a communication IF (not illustrated) in the billing server 301 or the visualizing server 302 to execute a computer program. The functions of the application system 300 according to the embodiment also include a storage unit 93. The storage unit 93 corresponds to a given memory area in an auxiliary storage device (not illustrated) provided to the billing server 301 or the visualizing server 302, for example.

The communication controller 30 controls data communications with the application system 300 and the MDMS 200. Specifically, the communication controller 30 transmits a request for acquiring a data sequence and a tentative signature to the MDMS 200, and receives the data sequence and the tentative signature from the MDMS 200 as a response to the acquisition request. The acquisition request thus transmitted includes target area identification information for identifying a target area whose amount of electrical power consumption is to be processed by the application, SM identification information for identifying the SM 100 in the target area, and summarization time information indicating the time at which the amount of electrical power consumption is summarized, for example.

The storage unit 93 stores therein the data sequence, the tentative signature, and the validation key to be used for signature validation received by the communication controller 30 from the MDMS 200.

The signature validator 31 validates if the tentative signature received from the MDMS 200 is a legitimate signature for the data sequence received from the MDMS 200. In other words, the signature validator 31 validates the data received from the MDMS 200, to confirm if the received data is not tampered. Because the signature validation method performed for this purpose is the same as that performed by the signature validator 21 included in the functions of the MDMS 200, a detailed explanation of the signature validation method is omitted herein.

If the signature validator 31 determines that the tentative signature is a legitimate signature for the data sequence (confirms that the received data is not tampered), the application executor 32 runs application software (a computer program achieving a function to be provided) on the received data sequence of the amounts of electrical power consumption, to provide a predetermined function. For example, the billing server 301 provides a billing function for calculating the total amount of electrical power consumptions over the billing period in the target area from the received data sequence of the amounts of electrical power consumption, and performing a billing process for the electrical power consumption in the target area based on the total amount of electrical power consumptions thus calculated. The visualizing server 302 provides a visualizing function for visualizing the amounts of electrical power consumption per unit time in the target area based on the received data sequence of the amounts of electrical power consumption.

In the manner described above, the functions of the electrical power consumption calculation system 1000 according to the embodiment are achieved by executing a computer program in each of the SM 100, the MDMS 200, and the application system 300, and by causing each of the functional units to work with one another.

Each of the computer programs is provided in a manner recorded as a file in an installable or executable format in a storage medium as a computer program product, which readable by the corresponding apparatus (computer) in an execution environment. For example, the computer program for the SM 100 has a modular configuration including each of these functional units, and each of these functional units are generated on the RAM in the main storage device 102 by causing the CPU 101 to read the computer program from the recording medium in the auxiliary storage device 103 and to execute the computer program. Means for providing the computer program is not limited to a storage medium. For example, the computer program may be stored in an external device connected to the Internet or the like, and may be downloaded over the data transfer channel NW. The computer program may also be provided in a manner incorporated in the ROM in the main storage device 102 or in the HDD in the auxiliary storage device 103 in advance.

A process performed in the electrical power consumption calculation system 1000 according to the embodiment (interoperations of the functional units) will now be explained using a flowchart. In the exemplary process described below, it is assumed that the target area for which the amount of electrical power consumption is to be summarized is a residence in which the SM 100 is installed. In the exemplary process described below, it is assumed that the time unit for which the amount of electrical power consumption is to be summarized is 15 minutes. It is also assumed that the number of data pieces included in the data sequence of the amounts of electrical power consumption is 96. It is also assumed that the retention term for which the data sequence of the amounts of electrical power consumption and the tentative signature are stored is two weeks. It is then assumed that the period of electrical power consumption on which the application is to be run is one month (30 days). In other words, in the exemplary process described below, the SM 100 summarizes the amount of electrical power consumptions in a residence once in 15 minutes, and generates one tentative signature for a data sequence of the amounts of electrical power consumption summarized at 96 points in time (over 24 hours). The SM 100 also stores therein the data (data sequence of the amounts of electrical power consumption and the tentative signature) for two weeks. The MDMS 200 stores therein a plurality of data sequences of the amounts of electrical power consumption each amount of which is summarized by the SM 100 (e.g., “data sequences corresponding to 10 years”), together with the respective signatures. The application system 300 requests the amounts of electrical power consumption from the MDMS 200 once in a month, and performs a process of billing each residence for the consumption over a month.

Process Performed by Functions of SM 100

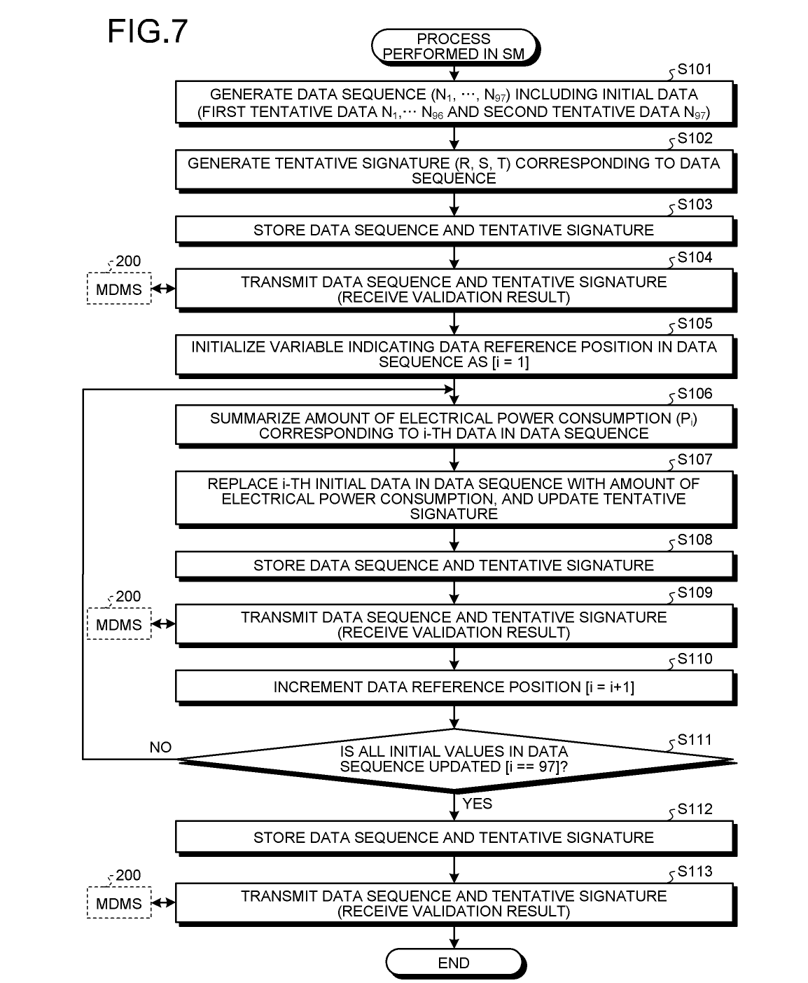

FIG. 7 is a flowchart illustrating an example of a process performed in the SM 100 according to the embodiment. As illustrated in FIG. 7, the signature generator 12 generates a data sequence (N₁, . . . , N₉₇) including initial values of measurement data of the amounts of electrical power consumption (first tentative data N₁, . . . , N₉₆ and second tentative data N₉₇) (Step S101). The signature generator 12 then generates a tentative signature (R, S, T) corresponding to the data sequence (Step S102). At this time, the signature generator 12 generates the tentative signature using the signature generating method described above, for example. The signature generator 12 then stores the data sequence and the tentative signature in the storage unit 91 (Step S103).

The communication controller (first transmitter) 10 then transmits the data sequence and the tentative signature thus generated to the MDMS 200 (Step S104). Before transmitting, the communication controller 10 may append summarization identification information, SM identification information, summarization time information, and the like to the data sequence and the tentative signature. The communication controller 10 may transmit the data sequence and the tentative signature after requesting data from the MDMS 200, or may transmit the data sequence and the tentative signature after receiving a data transmission request from the MDMS 200. After transmitting the data, the communication controller 10 may receive a validation result for the tentative signature from the MDMS 200. The timing at which the data sequence and the tentative signature are transmitted is not limited to Step S104. For example, the data may be transmitted at Step S109 or at Step S113. In such a case, the process at Step S104 is omitted.

The signature generator 12 stores therein the data sequence and the tentative signature (Step S103), transmits the data to the MDMS 200 as required (Step S104), and then initializes a variable i indicating the data reference position in the data sequence as [i=1] (Step S105).

The electrical power consumption summarizer 11 then summarizes the amount of electrical power consumption (first actual data Pᵢ) corresponding to the i-th piece of the first tentative data in the data sequence (Step S106). In response, the signature updater 13 replaces the i-th initial value (first tentative data Nᵢ) in the data sequence with the amount of electrical power consumption thus summarized (first actual data Pᵢ), and updates the tentative signature corresponding to the data sequence (Step S107). At this time, the signature updater 13 updates the tentative signature using the signature updating method described above, for example. The signature updater 13 then stores the data sequence having data replaced and the tentative signature thus updated in the storage unit 91 (Step S108).

The communication controller (first transmitter) 10 transmits the data sequence having data replaced and the tentative signature thus updated to the MDMS 200 (Step S109). As mentioned earlier, Step S109 is omitted when these pieces of data are transmitted at Step S104 or Step S113. When this process is executed after the data is transmitted at Step S104, a difference with respect to the data previously transmitted (a difference in the data sequence and a difference in the tentative signature) may be transmitted to the MDMS 200. For example, in the example described above, the actual measurement data (first actual data Pᵢ) of the electrical power consumptions having replaced the initial values (first tentative data Nᵢ) and an actual random number component (second actual data N₉₇′) having replaced the initial value serving as a random number component (second tentative data N₉₇) may be transmitted to the MDMS 200.

The signature updater 13 then stores therein the data sequence having data replaced and the tentative signature thus updated (Step S108), transmits these pieces of data to the MDMS 200 as required (Step S109), and increments the data reference position in the data sequence as [i=i+1] (Step S110).

The signature updater 13 then determines if the updating process is completed for all of the initial values in the data sequence (if the variable indicating the data reference position is equal to the number of data pieces in the data sequence [i==97]) (Step S111).

If the signature updater 13 determines that the updating process is not completed for all of the initial values in the data sequence (that the variable is not equal to the number of data pieces) (No at Step S111), the system control returns to Step S106, and the updating process is repeated until the condition of determination at Step S111 is satisfied.

If the signature updater 13 determines that the updating process is completed for all of the initial values in the data sequence (that the variable is equal to the number of data pieces) (Yes at Step S111), the signature updater 13 stores the data sequence having data replaced and the updated tentative signature in the storage unit 91 (Step S112). At this time, the signature updater 13 stores the data sequence having data replaced as a data sequence of the measurement data of the amounts of electrical power consumption plus one additional piece of data (97 pieces of data in total), and the updated tentative signature as a signature corresponding to the data sequence of the amounts of electrical power consumption. The signature updater 13 may omit the process of storing (Step S112) if the values of the data sequence and the tentative signature remain the same before and after the process at Step S112.

The communication controller (first transmitter) 10 then transmits the data sequence having data replaced and the updated tentative signature to the MDMS 200 (Step S113). As mentioned earlier, Step S113 is omitted if these pieces of data are transmitted at Step S104 or Step S109.

Once 96 time points (24 hours) elapse and the process up to Step S113 are completed, the process of the SM 100 may return to Step S101 again, and repeat the steps for another set of 96 time points (next 24 hours).

In this manner, in the electrical power consumption calculation system 1000 according to the embodiment, the SM 100 accumulates a sequence of data including the measurement data of the amounts of electrical power consumption, and a tentative signature corresponding to the data sequence.

Process Performed by Functions of MDMS 200

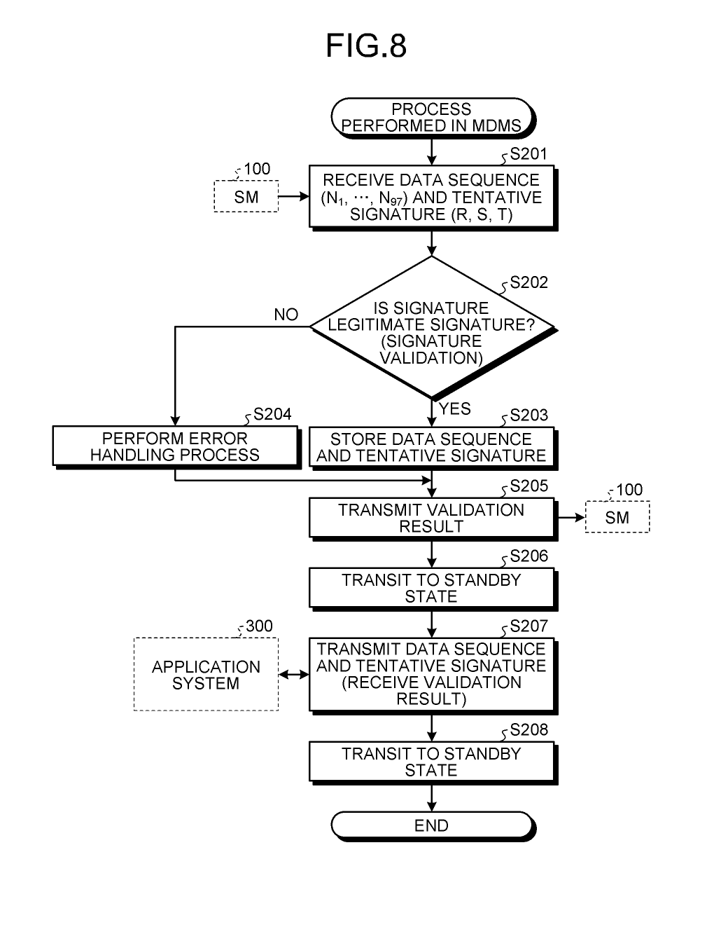

FIG. 8 is a flowchart illustrating an example of a process performed in the MDMS 200 according to the embodiment. As illustrated in FIG. 8, the communication controller (first receiver) 20 receives a data sequence (N₁, . . . , N₉₇) and a tentative signature (R, S, T) from the SM 100 (Step S201). At this time, the communication controller 20 may acknowledge the receipt of the data to the SM 100.

The signature validator (first validator) 21 validates the tentative signature received by the communication controller 20 to determine if the tentative signature thus received is a legitimate signature for the data sequence (Step S202). The signature validator 21 validates the tentative signature using the signature validation method described above, for example.

If the tentative signature is determined to be a legitimate signature for the data sequence (Yes at Step S202), the signature validator 21 stores the data sequence and the tentative signature thus received in the storage unit 92, with reference to the summarization identification information, the SM identification information, and the summarization time information (Step S203).

If the tentative signature is not determined to be a legitimate signature for the data sequence (No at Step S202), the signature validator 21 performs a predetermined error handling process (Step S204).

The communication controller 20 then transmits the validation result to the SM 100 (Step S205). The MDMS 200 then transits to a standby state (Step S206). Alternatively, the MDMS 200 may omit the process at Step S205, and may request retransmission of the data from the SM 100 if the tentative signature is not determined to be a legitimate signature for the data sequence at Step S202.

The communication controller (second transmitter) 20 transmits the data sequence and the tentative signature received from the SM 100 to the application system 300 (Step S207). The communication controller 20 may append the summarization identification information, the SM identification information, the summarization time information, and the like to the data sequence and the tentative signature to be transmitted. The communication controller 20 may also transmit the data sequence and the tentative signature after requesting data from the application system 300, or may transmit the data sequence and the tentative signature after receiving a request for a data transmission from the application system 300.

The MDMS 200 then transits to a standby state (Step S208).

In the manner described above, in the electrical power consumption calculation system 1000 according to the embodiment, the MDMS 200 validates a signature corresponding to a data sequence including measurement data of the amount of electrical power consumption, and transmits the data sequence and the signature to the application system 300.

Process Performed by Functions of Application System 300

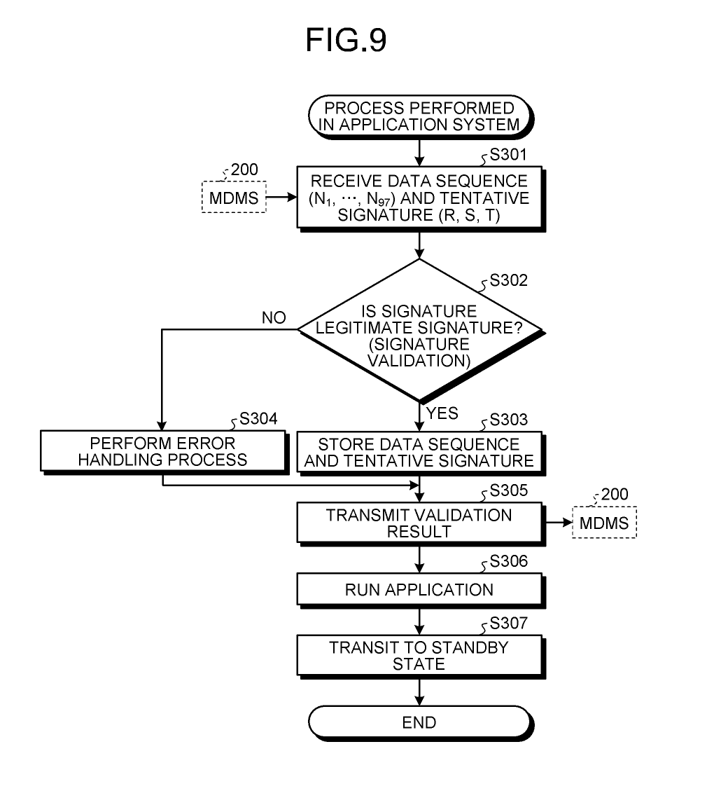

FIG. 9 is a flowchart illustrating an example of a process performed in the application system 300 according to the embodiment. As illustrated in FIG. 9, the communication controller (second receiver) 30 receives the data sequence (N₁, . . . , N₉₇) and the tentative signature (R, S, T) from the MDMS 200 (Step S301). At this time, the communication controller 30 may notify acknowledge the receipt of the data to the MDMS 200. The application system 300 may execute the process at Step S301 on a regular basis (every time a predetermined time indicating the timing for running the application elapses), or may execute the process at Step S301 in response to a request from a third party. For example, the billing server 301 included in the application system 300 may execute the process at Step S301 once in every one month, and may execute the process at Step S301 in response to an instruction issued by a person responsible for the billing process (a person who executes the billing process). The visualizing server 302 included in the application system 300 may execute the process at Step S301 after receiving a request for viewing the amounts of electrical power consumption from someone in the residence, or execute the process at Step S301 on a regular basis.

The signature validator (second validator) 31 then validates the tentative signature received from the MDMS 200 to determine if the tentative signature is a legitimate signature for the data sequence received from the MDMS 200 (Step S302). The signature validator 31 validates the tentative signature using the signature validation method described above, for example.

If the tentative signature is determined to be a legitimate signature for the data sequence (Yes at Step S302), the signature validator 31 stores the data sequence and the tentative signature received from the MDMS 200 in the storage unit 93, with reference to the summarization identification information, the SM identification information, and the summarization time information (Step S303).

If the tentative signature is not determined to be a legitimate signature for the data sequence (No at Step S302), the signature validator 31 performs a predetermined error handling process (Step S304).

The communication controller 30 then transmits the validation result to the MDMS 200 (Step S305). The application executor 32 then runs application software to provide the function of visualizing the amount of electrical power consumption or to provide the billing function (Step S306). The application system 300 then transits to a standby state (Step S307). Alternatively, the application system 300 may omit the process at Step S305, and may request retransmission of the data from the MDMS 200 if the tentative signature is not determined to be a legitimate signature for the data sequence at Step S302.

In the manner described above, in the electrical power consumption calculation system 1000 according to the embodiment, the application system 300 validates a signature corresponding to a data sequence including measurement data of the amount of electrical power consumption, and performs the process of visualizing the amount of electrical power consumption or the billing process based on the data sequence after validating the signature. In this manner, the electrical power consumption calculation system 1000 according to the embodiment provides an electrical power consumption management service with ensured data authenticity.

### SUMMARY

In the manner described above, in the electrical power consumption calculation system 1000 according to the embodiment, the SM 100 generates a data sequence including a predetermined number of pieces of the first tentative data each piece of which corresponds to the amount of electrical power consumption per unit time and a tentative signature in advance. The SM 100 then summarizes the amount of electrical power consumption per unit time (first actual data) in the target area. The SM 100 then replaces the first tentative data at the corresponding time with the amount of electrical power consumptions per unit time thus summarized (first actual data), and updates the data sequence and the tentative signature. Once all of the pieces of the first tentative data in the data sequence are replaced with the respective summarized amounts of electrical power consumption (first actual data), the tentative signature is updated as a signature corresponding to a data sequence of the amounts of electrical power consumption (first actual data). The SM 100 then transmits the data sequence and the tentative signature to the MDMS 200. When these pieces of data are received from the SM 100, the MDMS 200 retains the data. The MDMS 200 also transmits the data sequence and the tentative signature received from the SM 100 to the application system 300 in response to a request from the application system 300. When these pieces of data are received from the MDMS 200, the application system 300 runs the application based on the data thus received, to provide a predetermined function.

In this manner, the electrical power consumption calculation system 1000 according to the embodiment provides an environment in which the processing costs, e.g., a computational load and a processing time, in generating a signature are reduced. As a result, the electrical power consumption calculation system 1000 according to the embodiment can improve the processing efficiency while ensuring the data authenticity. Specifically, because the signature generating process can be executed in advance using the idle time of the CPU 101, the electrical power consumption calculation system 1000 according to the embodiment can reduce the processes performed after an actual measurement of the amount of electrical power consumption. Furthermore, when the amount of computations required in updating a signature is smaller than that in generating a signature, the signature generating method according to the embodiment enables measurements of electrical power consumptions to be transmitted quickly. Furthermore, because the signature generating method according to the embodiment does not generate one signature for each amount of electrical power consumption (because only one signature is required for a plurality of amounts of electrical power consumption), the signature size is independent of the number of data pieces in the data sequence (the signature size remains constant), whereby enabling the memory capacity to be reduced. Furthermore, the signature generating method according to the embodiment allows the signature to be validated every time the amount of electrical power consumption (first actual data) is measured and the tentative data is replaced (updated). Therefore, the authenticity of the data sequence of the amounts of electrical power consumption can be ensured.

Explained in the embodiment described above is an example in which the functions of the electrical power consumption calculation system 1000 are achieved by software implementation, but these functions are not limited to this. For example, a part or the whole of each of the functional units may be achieved by hardware (e.g., “circuit”) implementation.

Furthermore, in the embodiment, a data sequence for which a signature is generated is explained to be a sequence of data that is chronologically continuous, but the embodiment is not limited to such a data sequence. For example, the data sequence may be a data sequence including a plurality of data pieces summarized at the same time. More specifically, the data sequence may be a data sequence including pieces of the first tentative data corresponding to a plurality of the respective amounts of electrical power consumption (first actual data) summarized at the same time in a plurality of respective target areas.

### First Modification

Explained in the embodiment described above are a signature generating method, a signature updating method, and a signature validation method that use Equations (1) to (7). Disclosed in a first modification is an example enabling the processing efficiency to be improved while ensuring the sequence data authenticity by using a signature generating method, a signature updating method, and a signature validation method that are different from those according to the embodiment. In the explanation below, the same items as those in the embodiment are assigned with the same reference numerals, and explanations thereof will be omitted, and only the items that are different from those according to the embodiment will be explained hereunder.

Signature Generating Method

In a signature generator 12 according to the first modification, a tentative signature is calculated and generated using the following method. Explained in the embodiment is an example in which the calculations for generating a signature is performed using a chameleon hash function. For the purpose of convenience, in the description below, it is assumed that the unit time for which the amount of electrical power consumption is to be summarized is 15 minutes, and that the number of data pieces in a data sequence is 96. Detailed explanations of this method are substituted by the disclosure in Hugo Krawczyk, Tal Rabin: Chameleon Signatures. NDSS 2000.

To begin with, the signature generator 12 establishes 96 (which is the number of data pieces in a data sequence) pieces of the first tentative data N₁, . . . , N₉₆. The signature generator 12 then establishes 96 pieces of second tentative data r₁, . . . , r₉₆ each of which is equal to or more than zero and less than p, and calculates Equation (8) below. As the first tentative data and the second tentative data, a predetermined value, a random value, or a combination of these two may be used.

c₁=CH(N₁,r₁), . . . ,c₉₆=CH(N₉₆,r₉₆) (8)

The signature generator 12 then calculates the following Equation (9).

s=Sign(c₁, . . . ,c₉₆) (9)

As a result, the signature generator 12 establishes a tentative signature s. CH in Equation (8) is a chameleon hash function. Sign in Equation (9) is a signature generating function. For Sign, for example, a Rivest Shamir Adleman (RSA) signature, the elliptic curve digital signature algorithm (ECDSA), or the like is used. In the first modification, N₁, . . . , N₉₆ represents initial values of the measurement data of the amounts of electrical power consumption (first tentative data), and r₁, . . . , r₉₆ represent initial values of random number components (second tentative data). The signature generator 12 according to the embodiment generates a tentative signature using the method described above.

Signature Updating Method

The signature updater 13 replaces the j-th first tentative data Nⱼ with a measured amount of electrical power consumption Pⱼ after the electrical power consumption summarizer 11 measures the j-th amount of electrical power consumption (first actual data) Pⱼ and updates the random number components (second tentative data), to allow the tentative signature to be updated. The signature updater 13 updates the tentative signature by calculating the following Equation (10)

rⱼ′=ICH(Nⱼ,rⱼ,Pⱼ,cⱼ) (10)

where ICH in Equation (10) represents an inverse chameleon function. rⱼ′ calculated by Equation (10) satisfies CH(Nⱼ, rᵢ)=CH(Pⱼ, rᵢ′). In other words, the signature updater 13 according to the first modification corrects the random number components (second tentative data) in such a manner that the tentative signature before replacing the first tentative data Nⱼ with the amount of electrical power consumption (first actual data) Pⱼ becomes the same as the tentative signature after the replacement.

In the first modification, Pᵢ represents actual measurement data (second actual data) of the amount of electrical power consumption, and r₁′, . . . and r₉₆′ serve as the actual random number components (second tentative data) after all of N₁, . . . , N₉₆ are replaced with the actual measurements of the amounts of electrical power consumption. The random number component rⱼ′ updated by the signature updater 13 is redenoted as rⱼ, as long as such redenotation does not cause any confusion. The signature updater 13 according to the embodiment updates the tentative signature using the method described above.

Signature Validation Method

The signature validators 21, 31 validate the data sequence (N₁, . . . , N₉₇, r₁, . . . , r₉₆) and the tentative signature s using Equation (11) below. When Nᵢ (first tentative data) is replaced with the amount of electrical power consumption Pᵢ (first actual data), Nᵢ in Equation (11) is replaced with Pᵢ, and Equation (11) is then calculated:

Ver(CH(N₁,r₁), . . . ,CH(N₉₆,r₉₆),s) (11)

where Ver in Equation (11) represents a signature validating function corresponding to Sign.

As a result, if Equation (11) is established, the signature validators 21, 31 determine that the tentative signature being validated is not a legitimate signature for the data sequence (confirms that the received data is tampered), and do not store (discards) the tentative signature thus received. The signature validator 21 according to the embodiment validates the tentative signature using the method described above.

In the manner described above, in the first modification, the advantageous effects achieved in the embodiment can be achieved by using the signature generating method, the signature updating method, and the signature validation method described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A signature generating apparatus, comprising:
a generator configured to generate a data sequence including a predetermined number of pieces of first tentative data, and a tentative signature corresponding to the data sequence; and
an updater configured to update the tentative signature by replacing the piece of first tentative data with a piece of first actual data, and generate a signature corresponding to a data sequence including the pieces of first actual data by replacing all of the pieces of first tentative data with the respective pieces of first actual data.

2. The apparatus according to claim 1, wherein the generator is configured to calculate the tentative signature before the piece of first actual data is received.

3. The apparatus according to claim 1, further comprising a storage unit configured to store therein the piece of first tentative data having a predetermined value, as an initial value of the piece of first actual data in the data sequence, and store therein a piece of second tentative data having a predetermined value as an initial value of a piece of second actual data, wherein
the generator is configured to calculate the tentative signature based on the piece of first tentative data and one or more pieces of second tentative data.

4. The apparatus according to claim 3, wherein the updater is configured to read the piece of first tentative data and the piece of second tentative data from the storage unit, calculate the piece of second actual data to be used as a random number component by replacing the piece of first tentative data with the piece of first actual data, and update the piece of second tentative data with the piece of second actual data thus calculated.

5. The apparatus according to claim 1, further comprising a receiver configured to receive the piece of first actual data every time a predetermined time elapses.

6. The apparatus according to claim 1, wherein
the generator is configured to generate the tentative signature corresponding to the data sequence including the predetermined number of pieces of first tentative data and the data sequence including the pieces of first tentative data, and
the updater is configured to update the tentative signature by replacing the piece of first tentative data in the data sequence with a piece of measurement data representing a summarized amount of electrical power consumption as the piece of first actual data, and generate the signature corresponding to a data sequence including the pieces of measurement data for the amounts of electrical power consumption by replacing all of the pieces of first tentative data with the respective pieces of measurement data.

7. A signature generating method, comprising:
generating a data sequence including a predetermined number of pieces of first tentative data and a tentative signature corresponding to the data sequence;
updating the tentative signature by replacing the piece of first tentative data in a data sequence with a piece of first actual data; and
generating a signature corresponding to the data sequence including the pieces of first actual data by replacing all of the pieces of first tentative data with the respective pieces of first actual data.

8. The signature generating method according to claim 7, wherein the generating the data sequence includes calculating the tentative signature before the piece of first actual data is received.

9. The signature generating method according to claim 7, wherein
the piece of first tentative data having a predetermined value is stored in a storage unit as an initial value of the piece of first actual data in the data sequence,
a piece of second tentative data having a predetermined value is stored in the storage unit as an initial value of a piece of second actual data, and
the generating the data sequence includes calculating the tentative signature based on the piece of first tentative data and one or more pieces of second tentative data.

10. The signature generating method according to claim 9, wherein the updating includes
reading the piece of first tentative data and the piece of second tentative data from the storage unit,
calculating the piece of second actual data to be used as a random number component by replacing the piece of first tentative data with the piece of first actual data, and
updating the piece of second tentative data with the piece of second actual data thus calculated.

11. The signature generating method according to claim 7, further comprising receiving the piece of first actual data every time a predetermined time elapses.

12. The signature generating method according to claim 7, wherein
the generating the data sequence includes generating the tentative signature corresponding to the data sequence including the predetermined number of pieces of first tentative data and the data sequence including the pieces of first tentative data, and
the updating includes updating the tentative signature by replacing the piece of first tentative data in the data sequence with a piece of measurement data representing a summarized amount of electrical power consumption as the piece of first actual data, and generating the signature corresponding to a data sequence including the pieces of measurement data for the amounts of electrical power consumption by replacing all of the pieces of first tentative data with the respective pieces of measurement data.

13. A computer program product comprising a computer-readable medium containing a program executed by a computer, the program causing the computer to execute:
generating a data sequence including a predetermined number of pieces of first tentative data and a tentative signature corresponding to the data sequence;
updating the tentative signature by replacing the piece of first tentative data in a data sequence with a piece of first actual data; and
generating a signature corresponding to the data sequence including the pieces of first actual data by replacing all of the pieces of first tentative data with the respective pieces of first actual data.

14. The computer program product according to claim 13, wherein the generating the data sequence includes calculating the tentative signature before the piece of first actual data is received.

15. The computer program product according to claim 13, wherein
the piece of first tentative data having a predetermined value is stored in a storage unit as an initial value of the piece of first actual data in the data sequence,
a piece of second tentative data having a predetermined value is stored in the storage unit as an initial value of a piece of second actual data, and
the generating the data sequence includes calculating the tentative signature based on the piece of first tentative data and one or more pieces of second tentative data.

16. The computer program product according to claim 15, wherein the updating includes
reading the piece of first tentative data and the piece of second tentative data from the storage unit,
calculating the piece of second actual data to be used as a random number component by replacing the piece of first tentative data with the piece of first actual data, and
updating the piece of second tentative data with the piece of second actual data thus calculated.

17. The computer program product according to claim 13, the program causing the computer to further execute receiving the piece of first actual data every time a predetermined time elapses.

18. The computer program product according to claim 13, wherein
the generating the data sequence includes generating the tentative signature corresponding to the data sequence including the predetermined number of pieces of first tentative data and the data sequence including the pieces of first tentative data, and
the updating includes updating the tentative signature by replacing the piece of first tentative data in the data sequence with a piece of measurement data representing a summarized amount of electrical power consumption as the piece of first actual data, and generating the signature corresponding to a data sequence including the pieces of measurement data for the amounts of electrical power consumption by replacing all of the pieces of first tentative data with the respective pieces of measurement data.
